(19) United States
(12) Patent Application Publication
(10) Pub. No.: US 2007/0070011 A1
(43) Pub. Date: Mar. 29, 2007

(54) Active matrix liquid crystal display and driving method thereof

(75) Inventor: Teng-Tsung Tang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/526,492

(22) Filed: Sep. 25, 2006

(30) Foreign Application Priority Data
Sep. 23, 2005 (TW) 94133036

(51) Int. Cl. G09G 3/36

(52) U.S. Cl. 345/92

(57) ABSTRACT

An exemplary active matrix LCD (200) includes: a plurality of scanning lines (23) that are parallel to each other and that each extends along a first direction; a plurality of signal lines (24) that are parallel to each other and that each extends along a second direction different from the first direction; a plurality of thin film transistors (TFTs) (25) each provided in the vicinity of a respective point of intersection of the scanning lines and the signal lines; a plurality of pixel units, each pixel unit configured for being driven by a respective one of the TFTs; a gate driver (21) for providing a plurality of scanning signals to the scanning lines; a source driver (22) including a line latch (222). The line latch includes a reset terminal (26). The source driver provides a plurality of black-inserting voltages to the signal lines when the reset terminal receives a reset signal.

### FIELD OF THE INVENTION

The present invention relates to liquid crystal displays (LCDs), and particularly to an active matrix type LCD which is suitable for motion picture display and a driving method for driving the active matrix type LCD.

### BACKGROUND

Because LCD devices have the advantages of portability, low power consumption, and low radiation, they have been widely used in various portable information products such as notebooks, personal digital assistants (PDAs), video cameras, and the like. Furthermore, LCD devices are considered by many to have the potential to completely replace CRT (cathode ray tube) monitors and televisions.

FIG. 3 is an abbreviated diagram showing circuitry of a typical active matrix type LCD. The active matrix type LCD 100 includes a first substrate (not shown), a second substrate (not shown) facing the first substrate, a liquid crystal layer (not shown) sandwiched between the first substrate and the second substrate, a gate driver 11, a source driver 12, and a timing control circuit 17.

The first substrate includes a number n (where n is a natural number) of scanning lines 13 that are parallel to each other and that each extend along a first direction, and a number k (where k is also a natural number) of signal lines 14 that are parallel to each other and that each extend along a second direction orthogonal to the first direction. The first substrate also includes a plurality of thin film transistors (TFTs) 15 that function as switching elements. The first substrate further includes a plurality of pixel electrodes 151 formed on a surface thereof facing the second substrate. Each TFT 15 is provided in the vicinity of a respective point of intersection of the scanning lines 13 and the signal lines 14.

Each TFT 15 includes a gate electrode, a source electrode, and a drain electrode. The gate electrode is connected to the corresponding scanning line 13. The source electrode is connected to the corresponding signal line 14. The drain electrode is connected to the corresponding pixel electrode 151.

The second substrate includes a plurality of common electrodes 152 opposite to the pixel electrodes 151. In particular, the common electrodes 152 are formed on a surface of the second substrate facing the first substrate, and are made from a transparent material such as ITO (indium-tin oxide) or the like. A pixel electrode 151, a common electrode 152 facing the pixel electrode 151, and liquid crystal molecules of the liquid crystal layer sandwiched between the two electrodes 151, 152 cooperatively define a single pixel unit 153.

The source driver 12 includes a shift register 121, a line latch 122, a level shifter 123, a digital to analog (D/A) converter 124, and an output buffer 125 connected to the signal lines 14. The shift register 121 is a serial-in/parallel-out shift register consisting of a plurality of delay flip-flops (not shown). The gate driver 11 is connected to the scanning lines 13.

The timing control circuit 17 respectively generates a dot clock signal CLK1 and a scanning clock signal CLK2, and provides the dot clock siganl CLK1 and the scanning clock signal CLK2 to the shift register 121 of the source driver 12 and to the gate driver 11, respectively. The timing control circuit 17 further provides pixel data “PD” corresponding to image data to the line latch 122 of the source driver 12.

In sync with the dot clock siganl CLK1 supplied from the timing control circuit 17, the shift register 121 performs a shift operation for shifting a horizontal scanning pulse (not shown) supplied from the timing control circuit 17, and outputs a plurality of bits of parallel sampling pulses C₁-C_{K} (where K is a natural number equal to the number of signal lines 14) to the line latch 122. In sync with the sampling pulses C₁-C_{K} supplied from the shift register 121, the line latch 122 receives the pixel data “PD” supplied from the timing control circuit 17 over the duration of one horizontal synchronization period, and holds the pixel data “PD” therein. Then, the line latch 122 provides the pixel data “PD” to the level shifter 123. The level shifter 123 provides the pixel data “PD” to the D/A converter 124. The D/A converter 124 transforms the pixel data “PD” to a plurality of gradation voltages, and provides the gradation voltages to the output buffer 125. The output buffer 125 provides the gradation voltages to the signal lines 14. The duration of one horizontal synchronization period is approximately equal to K times a period of the dot clock siganl CLK1.

FIG. 4 is an abbreviated timing chart illustrating operation of the active matrix LCD 100. The scanning clock signal CLK2 is generated by the timing control circuit 17. Scanning signals G1-Gn are generated by the gate driver 11, and are applied to the scanning lines 13. The gradation voltages (VD) are generated by the source driver 12, and are sequentially applied to the signal lines 14. A common voltage Vcom is applied to all the common electrodes 152. Only one scanning signal pulse 19 is applied to each scanning line 13 during each single scan, the scanning signal pulse 19 having a duration which is equal to a period of the clock pulses of the scanning clock signal CLK2. The scanning signal pulses 19 are output sequentially to the scanning lines 13.

The gate driver 11 sequentially provides scanning pulses 19 (G1 to Gn) to the scanning lines 13, and activates the TFTs 15 respectively connected to the scanning lines 13. When the scanning lines 13 are thus scanned, the source driver 12 outputs gradation voltages VD corresponding to the image data to the signal lines 14. Then the gradation voltages are applied to the pixel electrodes 151 via the activated TFTs 15. The potentials of all the common electrodes 152 are set at a uniform potential. The gradation voltages VD written to the pixel electrodes 151 are used to control the amount of light transmission at the corresponding pixel units 153 and consequently provide an image display for the active matrix LCD 100.

In FIG. 4, the gradation voltage VD is a signal whose strength varies in accordance with each piece of image data, whereas the common voltage Vcom is a signal that has a constant value which does not vary at all.

If motion picture display is conducted on the active matrix LCD 100, problems of poor image quality may occur for a variety of reasons. For example, the residual image phenomenon may occur because a response speed of the liquid crystal molecules is too slow. In particular, when a gradation variation occurs, the liquid crystal molecules are unable to track the gradation variation within a single frame period, and instead produce a cumulative response during several frame periods. Consequently, considerable research is being conducted with a view to developing various high-speed response liquid crystal materials that can overcome this problem.

Further, the aforementioned problems such as the residual image phenomenon are not caused solely by the response speed of the liquid crystal molecules. For example, when the displayed image is changed in each frame period (the period that the gate driver 11 sequentially completes scanning from G1 to Gn once) to display the motion picture, the displayed image of one frame period may remain in a viewer's visual perception as an afterimage, and this afterimage overlaps with the viewer's perception of the displayed image of the next frame period. This means that from the viewpoint of a user, the image quality of the displayed image is impaired.

FIG. 5 is a timing chart illustrating a different mode of operation of the active matrix LCD 100, which mode is configured for mitigating or even eliminating any residual image effect of displayed images. For brevity, this mode of operation is referred to herein as a residual image reducing mode. The scanning signals G1-Gn are generated by the gate driver 11, and are applied to the scanning lines 13. The gradation voltages VD are generated by the source driver 12, and are sequentially applied to the signal lines 14.

The operation of the active matrix LCD 100 in residual image reducing mode includes the following steps:
a. A time frame “T” is divided into a first sub-frame “A” and a second sub-frame “B”.
b. In the first sub-frame “A”, the gate driver 11 sequentially provides a plurality of first scanning pulses 391 to the scanning lines 13, and activates the TFTs 15 respectively connected to the scanning lines 13.
c. When the scanning lines 13 are thus scanned, the source driver 12 outputs the gradation voltages VD corresponding to the image data to the signal lines 14. Then the gradation voltages are applied to the pixel electrodes 151 via the activated TFTs 15.
d. In the second sub-frame “B”, the gate driver 11 sequentially provides a plurality of second scanning pulses 392 to the scanning lines 13, and activates the TFTs 15 respectively connected to the scanning lines 13.
e. When the scanning lines 13 are thus scanned, the source driver 12 outputs a plurality of black-inserting voltages corresponding to black image data to the signal lines 14. Then the black-inserting voltages are applied to the pixel electrodes 151 via the activated TFTs 15.
f. In a next time frame “T”, the steps “a” through “e” are repeated.

In the operation of the active matrix LCD 100 in residual image reducing mode, the source driver 12 provides the gradation voltages VD corresponding to the image data to the signal lines 14. After about half of the time frame “T” has elapsed, the source driver 12 provides black-inserting voltages corresponding to the black image data to the signal lines 14. Accordingly, a viewer perceives the black image during the second sub-frame “B”, and an afterimage of the image displayed in the first sub-frame “A” is lost from the viewer's perception during the second sub-frame “B”. This means that there is no overlap of an afterimage with a perceived image of the next time frame “T”. Thus from the viewpoint of a user, the image quality of the displayed image is clear.

However, in the second sub-frame “B”, the black image data needs to be loaded in the line latch 122 in sync with the sampling pulses C₁-C_{K} supplied from the shift register 121 for the duration of one horizontal synchronization period each time. Then, the line latch 122 provides the black image data to the level shifter 123. The level shifter 123 provides the black image data to the D/A converter 124. The D/A converter 124 transforms the black image data into a plurality of black-inserting voltages, and provides the black-inserting voltages to the output buffer 125. The output buffer 125 provides the black-inserting voltages to the signal lines 14. As described above, in the second sub-frame “B”, the operation for the source driver 12 to provide the black-inserting voltages corresponding to the black image data to the signal lines 14 is very complicated.

It is desired to provide an active matrix LCD and a method for driving the active matrix LCD that can overcome the above-described deficiency.

### SUMMARY

An exemplary active matrix LCD includes a plurality of scanning lines that are parallel to each other and that each extends along a first direction; a plurality of signal lines that are parallel to each other and that each extends along a second direction different from the first direction; a plurality of thin film transistors (TFTs) each provided in the vicinity of a respective point of intersection of the scanning lines and the signal lines; a plurality of pixel units, each pixel unit is configured for being driven by a respective one of the TFTs; a gate driver for providing a plurality of scanning signals to the scanning lines; and a source driver including a line latch. The line latch includes a reset terminal. The source driver provides a plurality of black-inserting voltages to the signal lines when the reset terminal receives a reset signal.

An exemplary method for driving an active matrix liquid crystal display (LCD), the active matrix LCD including a gate driver, a plurality of scanning lines connected to the gate driver, a source driver, and a plurality of signal lines connected to the source driver, the source driver including a line latch, the method including: dividing a frame into a first sub-frame and a second sub-frame; in the first sub-frame, the gate driver providing a plurality of first scanning pulses sequentially to the plurality of scanning lines; when the scanning lines are thus scanned, the source driver outputting a plurality of gradation voltages corresponding to image data to the plurality of signal lines; in the second sub-frame, the gate driver providing a plurality of second scanning pulses to the scanning lines; and when the scanning lines are thus scanned, resetting the line latch of the source driver, such that the source driver outputs a plurality of black-inserting voltages corresponding to a black image to the signal lines.

Other advantages and novel features will become more apparent from the following detailed description when taken in conjunction with the accompanying drawings, in which:

### BRIEF DESCRIPTION OF THE DRAWINGS

FIG. 1 is an abbreviated diagram showing circuitry of an active matrix LCD according to an exemplary embodiment of the present invention;

FIG. 2 is an abbreviated timing chart illustrating operation of the active matrix LCD of FIG. 1 in a residual image reducing mode;

FIG. 3 is an abbreviated diagram showing circuitry of a conventional active matrix LCD;

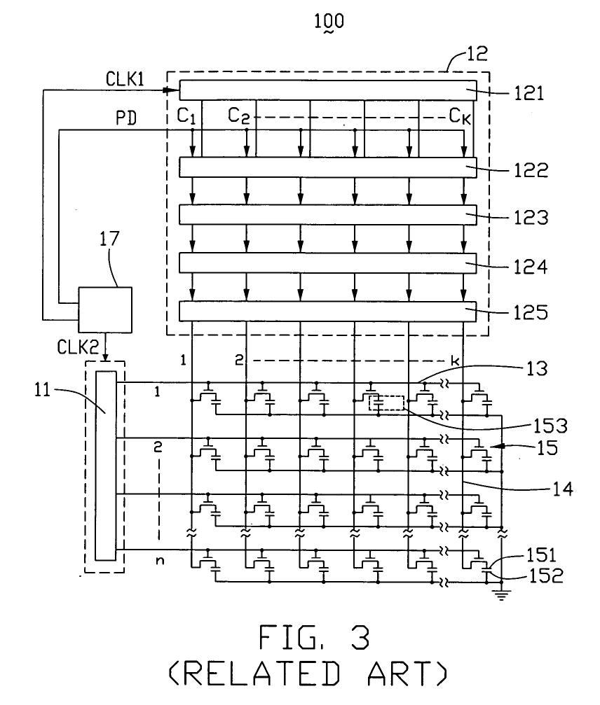

FIG. 4 is an abbreviated timing chart illustrating a normal mode of operation of the active matrix LCD of FIG. 3; and

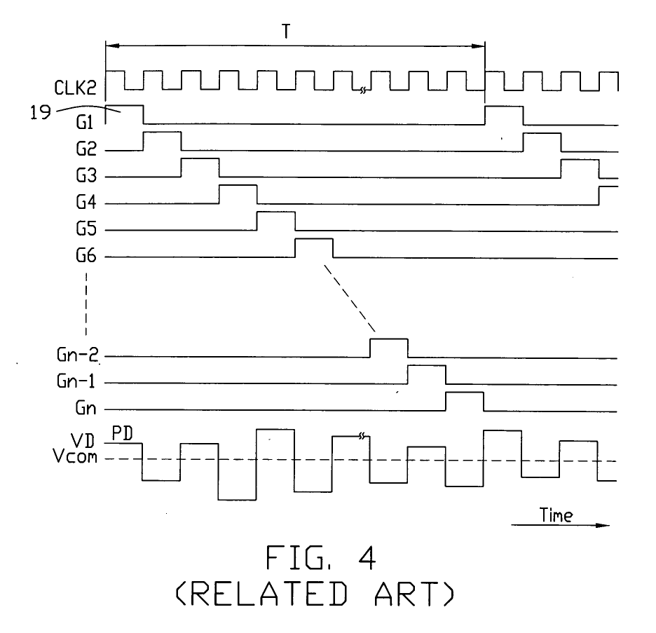

FIG. 5 is a timing chart illustrating a different operation of the active matrix LCD of FIG. 3, namely a residual image reducing mode.

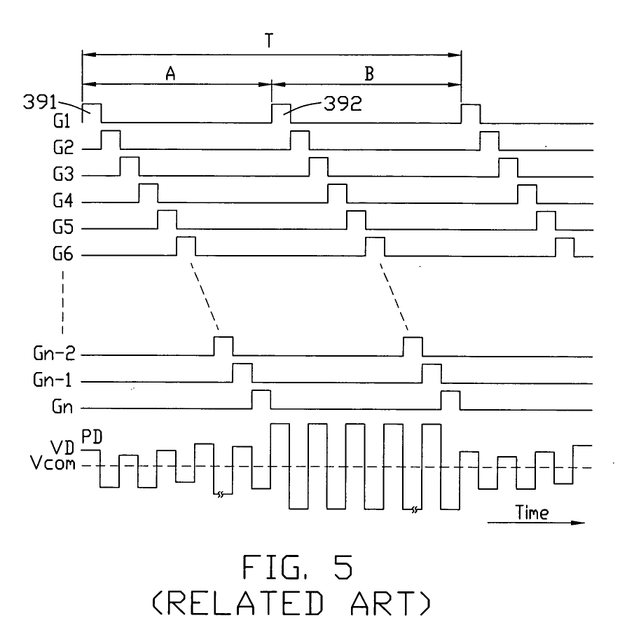

### DETAILED DESCRIPTION OF PREFERRED EMBODIMENTS

Reference will now be made to the drawings to describe the present invention in detail.

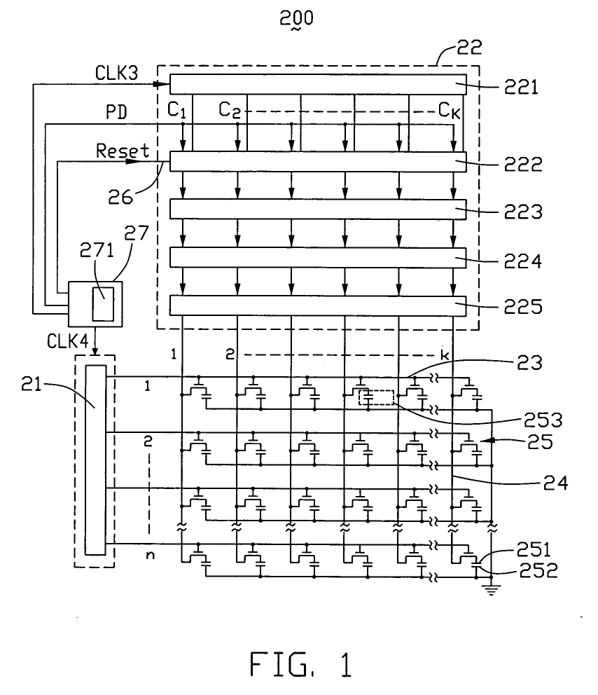

FIG. 1 is an abbreviated diagram showing circuitry of an active matrix LCD according to an exemplary embodiment of the present invention. The active matrix LCD 200 includes a first substrate (not shown), a second substrate (not shown) facing the first substrate, a liquid crystal layer (not shown) sandwiched between the first substrate and the second substrate, a gate driver 21, a source driver 22, and a timing control circuit 27.

The first substrate includes a number n (where n is a natural number) of scanning lines 23 that are parallel to each other and that each extend along a first direction, and a number k (where k is also a natural number) of signal lines 24 that are parallel to each other and that each extend along a second direction orthogonal to the first direction. The first substrate also includes a plurality of thin film transistors (TFTs) 25 that function as switching elements. The first substrate further includes a plurality of pixel electrodes 251 formed on a surface thereof facing the second substrate. Each TFT 25 is provided in the vicinity of a respective point of intersection of the scanning lines 23 and the signal lines 24.

Each TFT 25 includes a gate electrode, a source electrode, and a drain electrode. The gate electrode is connected to the corresponding scanning line 23. The source electrode is connected to the corresponding signal line 24. The drain electrode 25 is connected to the corresponding pixel electrode 251.

The second substrate includes a plurality of common electrodes 252 opposite to the pixel electrodes 251. In particular, the common electrodes 252 are formed on a surface of the second substrate facing the first substrate, and are made from a transparent material such as ITO (indium-tin oxide) or the like. A pixel electrode 251, a common electrode 252 facing the pixel electrode 251, and liquid crystal molecules of the liquid crystal layer sandwiched between the two electrodes 251, 252 cooperatively define a single pixel unit 253.

The timing control circuit 27 includes a clock circuit 271. The timing control circuit 27 respectively generates a dot clock signal CLK3 and a scanning clock signal CLK4, and provides the dot clock signal CLK3 and the scanning clock signal CLK4 to the source driver 22 and to the gate driver 21, respectively. The timing control circuit 27 further provides pixel data “PD” corresponding to image data to the source driver 22. In sync with the dot clock signal CLK3, the timing control circuit 27 generates a plurality of reset signals “Reset”, and provides the reset signals “Reset” to the source driver 22.

The source driver 22 includes a shift register 221, a line latch 222, a level shifter 223, a D/A converter 224, and an output buffer 225 connected to the signal lines 24. The line latch 222 includes a reset terminal 26 connected to the timing control circuit 27 for receiving the reset signals “Reset”. The shift register 221 is a serial-in/parallel-out shift register consisting of a plurality of delay flip-flops (not shown). The gate driver 21 is connected to the scanning lines 23.

When a reset signal “Reset” is provided to the reset terminal 26 of the line latch 222 from the timing control circuit 27, the line latch 222 performs a reset function. That is, the line latch 222 sets all the output terminals thereof to zero voltage, and provides the zero voltages to the level shifter 223. The level shifter 223 provides the zero voltages to the D/A converter 224. The D/A converter 224 transforms the zero voltages to a plurality of black-inserting voltages corresponding to a black image, and provides the black-inserting voltages to the output buffer 225. The output buffer 225 provides the black-inserting voltages to the signal lines 24.

When there is no reset signal provided to the reset terminal 26 of the line latch 222, in sync with the dot clock signal CLK3 supplied from the timing control circuit 27, the shift register 221 performs a shift operation for shifting a horizontal scanning pulse (not shown) supplied from the timing control circuit 27, and outputs a plurality of bits of parallel sampling pulses C₁-C_{K} (where K is a natural number equal to the number of signal lines 24) to the line latch 222. In sync with the sampling pulses C₁-C_{K} supplied from the shift register 221, the line latch 222 receives pixel data “PD” corresponding to the image data supplied from the timing control circuit 27 for the duration of one horizontal synchronization period, and holds the pixel data “PD” therein. Then, the line latch 222 provides the pixel data “PD” to the level shifter 223. The level shifter 223 provides the pixel data “PD” to the D/A converter 224. The D/A converter 224 transforms the pixel data “PD” into a plurality of gradation voltages, and provides the gradation voltages to the output buffer 225. The output buffer 225 provides the gradation voltages to the signal lines 24. The duration of one horizontal synchronization period is approximately equal to K times a period of the dot clock siganl CLK1.

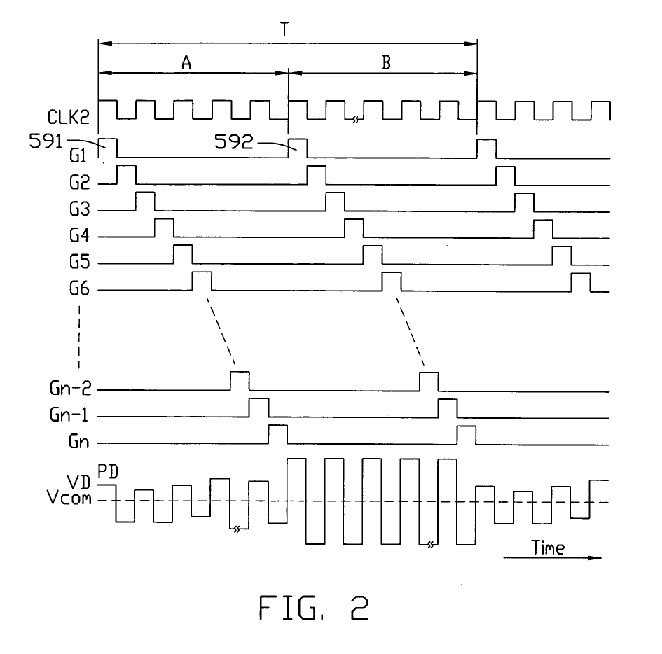

FIG. 2 is an abbreviated timing chart illustrating operation of the active matrix LCD 200 in a mode configured for mitigating or even eliminating any residual image effect of displayed images. For brevity, this mode of operation is referred to herein as a residual image reducing mode. Scanning signals G1-Gn are generated by the gate driver 21, and are applied to the scanning lines 23. The gradation voltages (VD) are generated by the source driver 22, and are sequentially applied to the signal lines 24. The operation of the active matrix LCD 200 in residual image reducing mode includes the following steps:
a. A time frame “T” is divided into a first sub-frame “A” and a second sub-frame “B”.
b. In the first sub-frame “A”, the gate driver 21 sequentially provides a plurality of
first scanning pulses 591 to the scanning lines 23, and activates the TFTs 25 respectively connected to the scanning lines 23.
c. When the scanning lines 23 are thus scanned, the source driver 22 outputs the gradation voltages VD corresponding to image data to the signal lines 24. Then the gradation voltages are applied to the pixel electrodes 251 via the activated TFTs 25.
d. In the second sub-frame “B”, the gate driver 21 sequentially provides a plurality of second scanning pulses 592 to the scanning lines 23, and activates the TFTs 25 respectively connected to the scanning lines 23.
e. When the scanning lines 23 are thus scanned, the timing control circuit 27 provides a reset signal “Reset” to the reset terminal 26 of the line latch 222. The line latch 222 performs a reset function, and the source driver 22 outputs a plurality of black-inserting voltages corresponding to a black image. Then the black-inserting voltages are applied to the pixel electrodes 251 via the activated TFTs 25.
f. In a next time frame “T”, the steps “a” through “e” are repeated.

The first sub-frame “A” can be equal to, longer than, or shorter than the second sub-frame “B”. For example, when the first sub-frame “A” is longer than the second sub-frame “B”, the first and second sub-frames “A”, “B” can be set to sixty percent of a time frame “T” and forty percent of the time frame “T”, respectively. When the first sub-frame “A” is shorter than the second sub-frame “B”, the first and second sub-frames “A”, “B” can be set to forty percent of a time frame “T”, and sixty percent of the time frame “T”, respectively.

In summary, the source driver 22 includes the line latch 222, which includes the reset terminal 26 connected to the timing control circuit 27 for receiving the reset signals “Reset”. When a reset signal is provided to the reset terminal 26 of the line latch 222 from the timing control circuit 27, the line latch 222 performs a reset function, and the source driver 22 outputs a plurality of black-inserting voltages corresponding to a black image. Thus, the operation of the active matrix LCD 200 in residual image reducing mode is simple.

In a further or alternative embodiment or embodiments, in order to eliminate any residual image generated or perceived when the LCD 200 is powered on or powered off, the timing control circuit 27 can provide a reset signal “Reset” to the reset terminal 26 of the line latch 222 when the LCD is powered on or powered off.

It is to be understood, however, that even though numerous characteristics and advantages of exemplary and preferred embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An active matrix liquid crystal display (LCD), comprising:
a plurality of scanning lines that are parallel to each other and that each extend along a first direction;
a plurality of signal lines that are parallel to each other and that each extend along a second direction different from the first direction;
a plurality of thin film transistors (TFTs), each provided in the vicinity of a respective point of intersection of the scanning lines and the signal lines;
a plurality of pixel units, each pixel unit configured for being driven by a respective one of the TFTs;
a gate driver for providing a plurality of scanning signals to the scanning lines; and
a source driver comprising a line latch, the line latch comprising a reset terminal, the source driver configured for providing a plurality of black-inserting voltages to the signal lines when the reset terminal receives a reset signal.

2. The active matrix LCD as claimed in claim 1, wherein each of the pixel units comprises a pixel electrode, a common electrode, and liquid crystal molecules sandwiched between the pixel electrode and the common electrode.

3. The active matrix LCD as claimed in claim 1, further comprising a timing control circuit, which is configured for providing the reset signal to the reset terminal of the line latch.

4. The active matrix LCD as claimed in claim 3, wherein the timing control circuit is configured for respectively generating a dot clock and a scanning clock, and for providing the dot clock and the scanning clock to the source driver and the gate driver, respectively.

5. A method for driving an active matrix liquid crystal display (LCD), the active matrix LCD comprising a gate driver, a plurality of scanning lines connected to the gate driver, a source driver, and a plurality of signal lines connected to the source driver, the source driver comprising a line latch, the method comprising:
a. dividing a frame into a first sub-frame and a second sub-frame;
b. in the first sub-frame, the gate driver providing a plurality of first scanning pulses sequentially to the plurality of scanning lines;
c. when the scanning lines are thus scanned, the source driver outputting a plurality of gradation voltages corresponding to image data to the plurality of signal lines;
d. in the second sub-frame, the gate driver providing a plurality of second scanning pulses to the scanning lines; and
e. when the scanning lines are thus scanned, resetting the line latch of the source driver, such that the source driver outputs a plurality of black-inserting voltages corresponding to a black image to the signal lines.

6. The method as claimed in claim 5, wherein the first sub-frame is equal to the second sub-frame.

7. The method as claimed in claim 5, wherein the first sub-frame is longer than the second sub-frame.

8. The method as claimed in claim 7, wherein the first sub-frame and the second sub-frame are set to sixty percent of a frame and forty percent of the frame, respectively.

9. The method as claimed in claim 5, wherein the first sub-frame is shorter than the second sub-frame.

10. The method as claimed in claim 9, wherein the first sub-frame and the second sub-frame are set to forty percent of a frame and sixty percent of the frame, respectively.

11. The method as claimed in claim 5, further comprising providing a reset signal to a reset terminal of the line latch when the active matrix LCD is powered on.

12. The method as claimed in claim 5, further comprising providing a reset signal to a reset terminal of the line latch when the active matrix LCD is powered off.

13. An active matrix liquid crystal display (LCD), comprising:
a plurality of scanning lines that are parallel to each other and that each extend along a first direction;
a plurality of signal lines that are parallel to each other and that each extend along a second direction different from the first direction;
a gate driver for providing a plurality of scanning signals to the scanning lines; and
a source driver comprising a line latch, the line latch comprising a reset terminal, the source driver configured for providing a plurality of black-inserting voltages to the signal lines when the reset terminal receives a reset signal.
